(19) United States
(12) Patent Application Publication
(10) Pub. No.: US 2010/0306572 A1
(43) Pub. Date: Dec. 2, 2010

(54) Apparatus and method to facilitate high availability in secure network transport

(76) Inventors: Alexandro Salvarani, Edison, NJ (US); Tiberiu Grigoriu, Ottawa (CA)

Correspondence Address: Alcatel-Lucent USA Inc.;Docket Administrator, Room 2F-192, 600-700 Mountain Ave., Murray Hill, NJ, 07974-0636, US

(21) Appl. No.: 12/455,357

(22) Filed: Jun. 1, 2009

(51) Int. Cl. G06F 21/00; G06F 11/14

(52) U.S. Cl. 714/4; 726/12; 714/E11.113

(57) ABSTRACT

Embodiments described herein are effective to detect, repair and recover automatically IPSec tunnels due to failures of transport gear (L2/L3 switches) as well as the IPsec gateway components. Load balance is also an integral part of the approach. When a failure is repaired, the architecture in various embodiments will re-establish load balance and high availability automatically at L2 and L3 and preserve security during the switch-over and recovery process.

### FIELD OF THE INVENTION

The present invention relates generally to communication systems and, in particular, to facilitating high availability in secure network transport.

### BACKGROUND OF THE INVENTION

High availability in secure systems is often achieved via redundancy. For transport networks, such as wireless backhaul networks, the existing solutions are not scalable and do not have automatic recovery when failure occurs while maintaining security. Switchover times are sufficiently long such that existing services (e.g., VoIP calls) are terminated, with visible impact in performance. In today's fast switching networks, a system architecture incorporating new techniques is needed to maintain security, reliability and load balance so that transport resources can be recovered quickly to prevent service interruption.

### BRIEF DESCRIPTION OF THE DRAWINGS

FIG. 1 is a block diagram depiction of a network topology in accordance with multiple embodiments of the present invention.

FIG. 2 is a block diagram depiction of a network response to a downlink failure in accordance with multiple embodiments of the present invention.

FIG. 3 is a block diagram depiction of a network response to another downlink failure in accordance with multiple embodiments of the present invention.

FIG. 4 is a block diagram depiction of a network response to an uplink failure in accordance with multiple embodiments of the present invention.

FIG. 5 is a block diagram depiction of a network response to another uplink failure in accordance with multiple embodiments of the present invention.

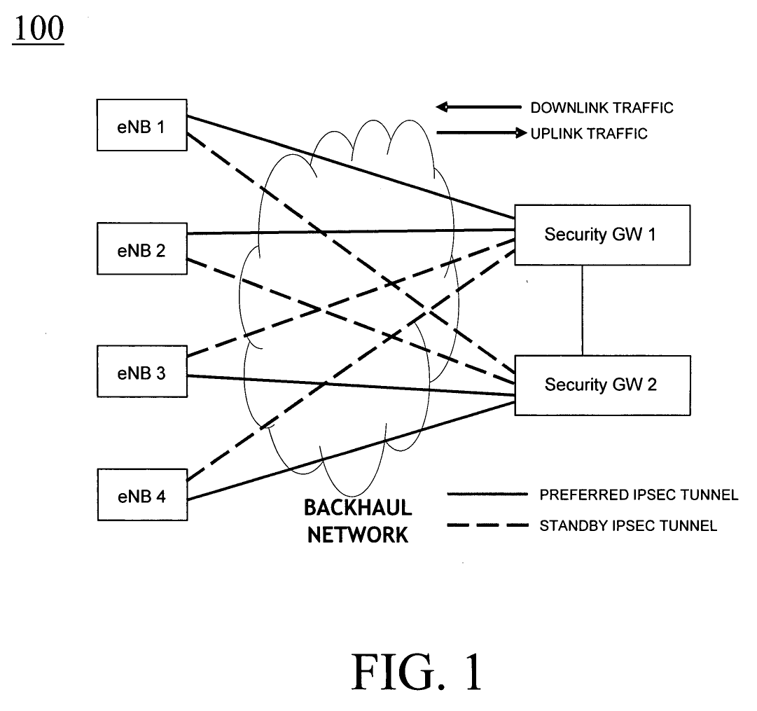

Specific embodiments of the present invention are disclosed below with reference to FIGS. 1-5. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

The advent of wireless high speed packet data has caused the Radio Access Network (RAN) in wireless networks to evolve from a circuit switched to a packet switched “all IP” network, in an effort to meet high capacity demand efficiently and to interface and operate with other packet data networks. As these IP networks are deployed, wireless operators demand the transport services to be reliable. Furthermore, the transport network elements are required to operate at high availability in a secure environment while maintaining high data throughout capacity.

While the performance of traditional transport networks is determined by the bandwidth limitations and by the reliability requirements (networks use some form of sparing scheme to meet the reliability objectives), it is possible to operate the transport gear in a manner that is limited by the hardware capacity. This may be done by performing load balance and fault management at the same time, such that the hardware is utilized more efficiently.

In addition, “all IP” networks, telecommunication equipment and computers use open interfaces and protocols for communication based on the TCP/IP protocol suite, which makes them vulnerable to internal and external attacks. These network assets need to be protected against these threats, as required by the service operators.

One way to protect the network equipment and traffic in transit is to protect the layer 3 (L3) traffic by using IPsec tunnels. IPsec tunnels protect the network interfaces and the L3 traffic and above layers by supporting host authentication, traffic confidentiality, integrity protection, anti-replay and non-repudiation on a per IP packet basis. Even if IPsec is an effective security solution reaching many security dimensions, the failure of an IPsec tunnel creates a reliability condition that must be addressed. This is particularly important in large networks with many hosts, where the likelihood of failures and security attacks is higher. In order to provide a reliable L3 transport with high availability while preserving the security policies during failures requires resource diversity, usually implemented via some form of redundancy. In order to provide an automatic recovery service to overcome IPsec failures that is self-healing and requires no manual intervention, several components are proposed: a detection mechanism to detect tunnel failure; a trigger mechanism driven by the detection system to initiate recovery procedures; a fault management recovery procedure to switchover the traffic while preserving security; and a mechanism of detection and activation to switch back to the original network configuration, after detecting that the failed equipment has been repaired, to re-establish load balance, all while preserving security.

Such actions should be performed quickly in order to maintain high levels of quality of service. For instance, a reliability requirement driven by some service providers is to implement security in the backhaul network without significant impact in the overall end-to-end availability. This means IPsec detection, switchover and recovery should be done very quickly to prevent VoIP call drops and other service discontinuities.

Thus, in view of the desires of system operators, a system should provide a transport solution that support load balance, high availability and security with high performance. The main components of such a solution are: a fault management mechanism for high availability, load balance of backhaul traffic and secure communication.

The present invention can be more fully understood with reference to FIGS. 1-5. FIG. 1 is a block diagram depiction of a network topology in accordance with multiple embodiments of the present invention. It should be understood that wireless communication systems typically include a plurality of mobile units, a plurality of network nodes, and additional equipment; however, only network nodes (eNBs 1-4) security gateways (Security GW 1 and Security GW 2) are depicted in diagram 100 for the sake of clarity.

In general, network nodes and security gateways are known to comprise components such as processing units and network interfaces. In addition and again generally speaking, processing units and network interfaces are well-known components themselves. For example, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using signaling flow diagrams, and/or expressed using logic flow diagrams.

Thus, given a high-level description, an algorithm, a logic flow, a messaging/signaling flow, and/or a protocol specification, those skilled in the art are aware of the many design and development techniques available to implement a processing unit that performs the given logic. Therefore, network nodes and security gateways represent a known devices that have been adapted, in accordance with the description herein, to implement multiple embodiments of the present invention. Furthermore, those skilled in the art will recognize that aspects of the present invention may be implemented in and across various physical components and none are necessarily limited to single platform implementations. For example, processing units and/or network interfaces, in either network nodes or security gateways, may be implemented in or across one or more network components, such as one or more network platforms/servers. Also, although the network nodes in the figures are depicted as eNBs, thereby providing a concrete example to the reader, network nodes can be more generally characterized as IP hosts implemented in or across one or more network components, such as one or more network platforms/servers.

Diagram 100 shows an example network topology to illustrate some basic principles that further some desired architecture goals. High availability is achieved by using redundancy. The simplest level of redundancy is a 1+1 system where functions are supported in two identically prepared mate systems. Security GW 1 and Security GW 2 are two mates of a single system called the Security Gateway. The system is designed to support the designed processing capacity with the two mates, or with a single mate, in case the other mate is down. During normal operation, many IP hosts (eNB1, eNB2, eNB3,eNB4) are connected to the security gateway. For large networks, the Security GW can terminate many hundreds of eNBs, and for powerful Security GWs, a single Security Gateway can terminate many thousand of eNBs. High availability is achieved via a redundant 1+1 system. In this approach, load balance is achieved via the configuration deployment. This means that during normal operation (i.e., when both Security GW mates are up and running), half of the eNB IP hosts are connected to Security GW1, while the other half of the eNBs are connected to Security GW2, as shown in diagram 100. The specific interfaces between the eNBs and the Security GWs are provisioned during initialization of each eNB, and do not need to be modified during operation.

Communication security is provided via IPsec. Each IPsec tunnel terminates at an eNB and at a Security Gateway. In order to be secure and reliable on the Security Gateways, each eNB terminates two IPsec tunnels: one tunnel connected to Security GW1 and one tunnel connected to Security GW2. Since in this example, the eNB hardware is not duplicated, it represents a single point of failure. However, due to concentration, it is far more important to have the Security Gateway reliable than a single eNB, and it is far cheaper to implement when compared to eNB high availability.

During normal operation, traffic is load balanced with a granularity of a single eNB and transport is secure. When a failure occurs, resources must be switched to address the failure and re-establish service. Each traffic direction (downlink and uplink) must be treated separately, because redundancy is asymmetric. For a system where both, the eNB and the Security Gateways are duplicated, one can apply the same ideas described in this approach in a symmetric manner for downlink and uplink traffic.

Specifically, in a scenario where the eNB and the Security Gateway are both redundant, the ideas proposed herein can be extended to each eNB mate, where each eNB mate is connected with each Security Gateway mate for a total of four independent connections. In this configuration each eNB1 mate behaves in the same manner as the single eNB1 scenario, but the security gateway mates must route the downlink traffic to the preferred IPsec tunnel, or if not available, to the alternate IPsec tunnel.

Central to the implementation of load balance and security is the concept of a preferred IPsec tunnel. The preferred IPSec tunnel is the one that, if operational, is the one chosen to send traffic by the sender. The preferred tunnel is set on a per eNB basis (but alternatively could be set per interface), and represents the mechanism to load balance the traffic during normal operation. For load balance, half the eNBs have their preferred IPsec tunnels assigned to the top Security Gateway (SGW1), while the other half of the eNBs have their preferred IPsec tunnel assigned to the bottom Security Gateway (SGW2). The preferred IPsec tunnel is provisioned at the eNb and at the security Gateway interfaces, and they are assigned to the same IPsec physical tunnel. This is desirable in order to be able to load balance the downlink and the uplink at the same time. This can also simplify the IPsec policy implementation and troubleshooting, specially during the phase of recovery and re-establishment of the load balance condition.

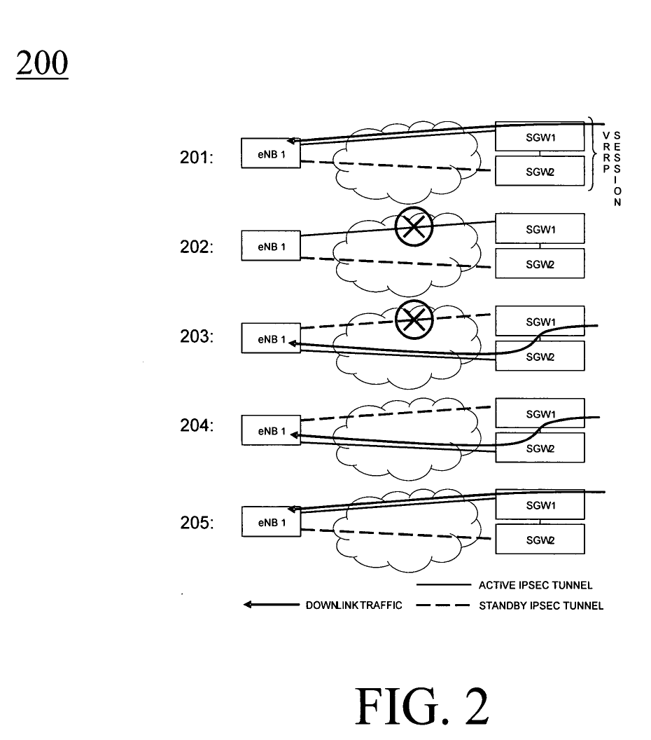

FIG. 2 is a block diagram depiction of a network response to a downlink failure in accordance with multiple embodiments of the present invention. In particular, the failure addressed in diagram 200 is a tunnel failure. Two IPsec tunnels are configured between each eNB and the Security Gateway. In the downlink, the eNB listen to both IPsec tunnels simultaneously. In this approach, if Security Gateway SGW1 fails, the Security Gateway will switch traffic over to the other tunnel, and the eNB does not need to know about the switchover.

In this downlink approach, a preferred IPsec tunnel is configured per eNb. Both the eNB and the Security Gateway should be provisioned with this information. At any given time, the Security Gateway monitors the preferred IPSec tunnel, and if the tunnel is running correctly, the Security Gateway sends traffic to the eNB via the preferred IPsec tunnel. If the preferred tunnel fails in the downlink, the Security Gateway routes traffic via the alternative IPsec tunnel. When the preferred IPsec tunnel is operational, the Security Gateway switches routes again so that it sends downlink link traffic to the eNB via the preferred IPsec tunnel. In this way, load balance is re-establish after the repair of the failure is completed and the outage is fixed. As an illustration, the following steps describe in detail how a network thus configured would handle downlink failure due to tunnel failure:
STEP 201: Downlink traffic arrives to Virtual Router Redundancy Protocol (VRRP) master SGW1. SGW1 uses routing to send IP packets through the preferred active tunnel to eNB1.
STEP 202: Active tunnel fails and dead peer detection (DPD) (or perhaps some other heartbeat mechanism) in SGW1 detects failure. The Downlink traffic is temporarily interrupted.
STEP 203: Route in SGW1 is updated due to tunnel failure. Downlink IP packets are routed to SGW2, and then into the SGW2 tunnel.
STEP 204: Failed tunnel is repaired, and IPsec is up and running again. SGW1 will try to re-start the IPsec tunnel as soon as the facility is available.
STEP 205: SGW1 detects that a preferred tunnel is in service. This triggers a route update in SGW1 so that SGW1 send downlink packets through the preferred tunnel. Load balance has been re-established automatically without manual intervention.

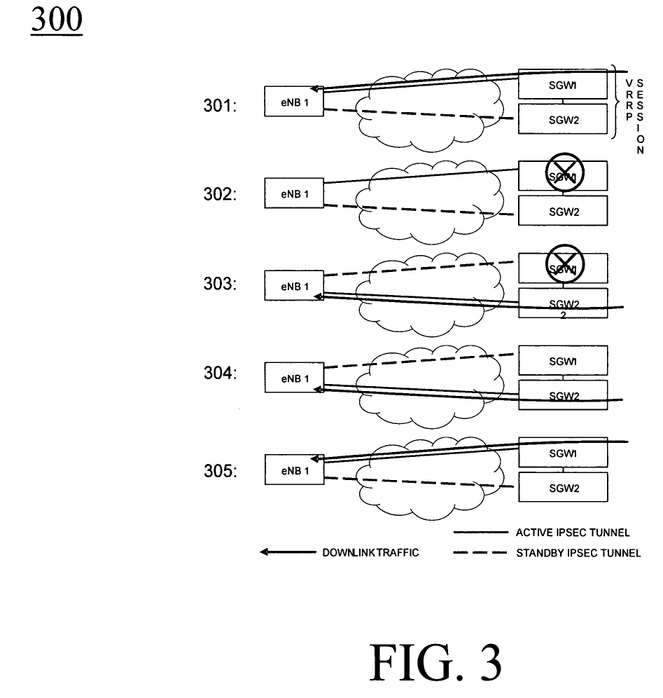

FIG. 3 is a block diagram depiction of a network response to another downlink failure in accordance with multiple embodiments of the present invention. In particular, the failure addressed in diagram 300 is a tunnel failure due to a Security GW1 failure. As an illustration, the following steps describe in detail how a network thus configured would handle downlink failure due to an SGW1 failure:
STEP 301: SGW1 is the VRRP master. Downlink traffic arrives to SGW1 which uses routing to send IP packets through the active (preferred) tunnel to eNB1.
STEP 302: SGW1 fails and SGW2 becomes the new VRRP master. Downlink traffic is interrupted while VRRP converges.
STEP 303: Downlink traffic arrives at SGW2 and is routed to eNB1 via the active tunnel connected to SGW2.
STEP 304: Downlink IP packets are routed as in step 303. In the mean time, SGW1 failure is repaired and SGW1 is back in service. SGW1 will automatically re-start Internet Key Exchange (IKE) with eNB1 and the IPsec tunnel is recovered.
STEP 305: VRRP master is switched to SGW1, which uses the IPsec tunnel connected to SGW1 to send traffic to eNB1. Downlink load balance has been re-established automatically without manual intervention.

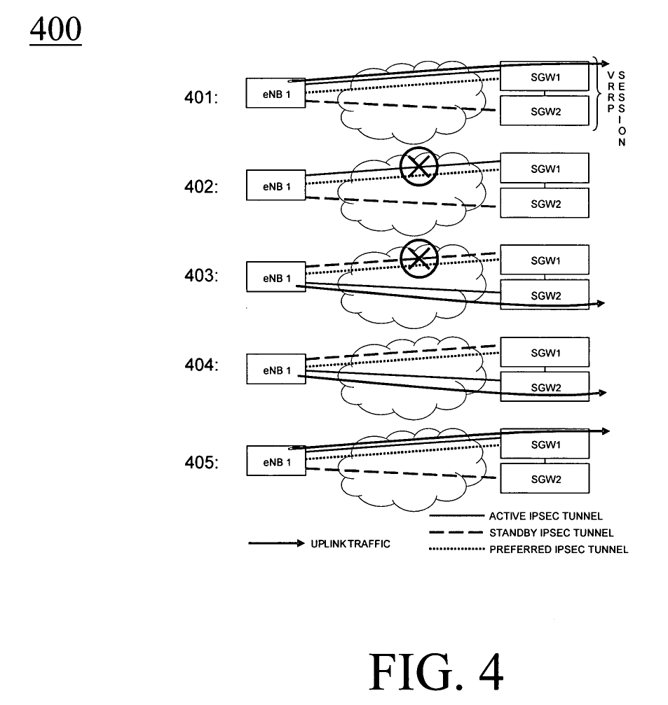

FIG. 4 is a block diagram depiction of a network response to an uplink failure in accordance with multiple embodiments of the present invention. In particular, the failure addressed in diagram 400 is a tunnel failure. In the uplink channel, the eNB1 decides which IPsec tunnel to use to send traffic to the Security Gateway. The rule is as follows: if the preferred IPsec tunnel is operational, the eNB1 will always send IPsec traffic through the preferred tunnel. When this IPsec tunnel fails, the eNB1 then sends traffic through the alternative IPsec tunnel. When the failed preferred IPsec tunnel is repaired and back in operation, the eNB1 detects that the preferred IPsec tunnel is up again. This event triggers the eNB1 to send traffic via the preferred IPsec tunnel again to re-establish load balance. The preferred IPsec tunnel is, in these examples, provisioned to achieve load balance. As an illustration, the following steps describe in detail how a network thus configured would handle an uplink failure due to tunnel failure:
STEP 401: The preferred IPsec tunnel for eNB1 is the tunnel connected to SGW1. Since this tunnel is up, eNB1 sends all uplink traffic to SGW1. DPD (or perhaps some other heartbeat mechanism) is running at eNB1 to check the liveness of SGW1 and SGW2. eNB1 routing table contains one static route that routes the uplink traffic to SGW1.
STEP 402: tunnel to SGW1 fails. DPD in eNB1 detects the tunnel to be down. Uplink traffic is sent to a black hole.
STEP 403:Triggered by DPD failure, eNB1 removes the uplink static route to SGW1, and adds the static route to SGW2. Uplink traffic is routed from eNB1 to SGW2.
STEP 404: Uplink IP packets are routed as in step 403. In the mean time, the tunnel failure is repaired. SGW1 will automatically re-start IKE with eNB1 and the IPsec tunnel is recovered. DPD running on eNB1 will detect IPsec to SGW1 to be up.
STEP 405: DPD in eNB1 triggers update of static route for uplink traffic. The static route to SGW2 is replaced by the static route to SGW1. Uplink load balance has been re-established.

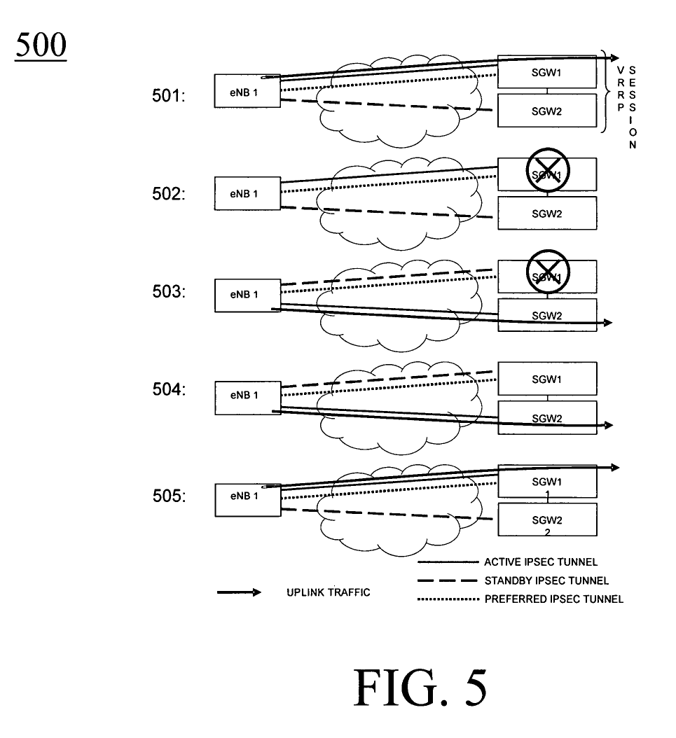

FIG. 5 is a block diagram depiction of a network response to another uplink failure in accordance with multiple embodiments of the present invention. In particular, the failure addressed in diagram 500 is a tunnel failure due to a Security Gateway failure. As an illustration, the following steps describe in detail how a network thus configured would handle an uplink failure due to an SGW1 failure:
STEP 501: The preferred IPsec tunnel for eNB1 is the tunnel connected to SGW1. Since this tunnel is up, eNB1 sends all uplink traffic to SGW1. DPD (or perhaps some other heartbeat mechanism) is running at eNB1 to check the liveness of SGW1 and SGW2. eNB1 routing table contains one static route that routes the uplink traffic to SGW1.
STEP 502: SGW1 fails. DPD in eNB1 detects the tunnel to be down. Uplink traffic is sent to a black hole.
STEP 503:Triggered by DPD failure, eNB1 removes the uplink static route to SGW1, and adds the static route to SGW2. Uplink traffic is routed from eNB1 to SGW2.
STEP 504: Uplink IP packets are routed as in step 503. In the mean time, the tunnel failure is repaired. SGW1 will automatically re-start IKE with eNB1 and the IPsec tunnel is recovered. DPD running on eNB1 will detect IPsec to SGW1 to be up.
STEP 505: DPD in eNB1 triggers update of static route for uplink traffic. The static route to SGW2 is replaced by the static route to SGW1. Uplink load balance has been re-established.

In general, some, if not all, of the embodiments described herein are effective to detect, repair and recover automatically IPSec tunnels due to failures of transport gear (L2/L3 switches) as well as the IPsec gateway components. Load balance is also an integral part of the approach. When a failure is repaired, the architecture in various embodiments will re-establish load balance and high availability automatically at L2 and L3 and preserve security during the switch-over and recovery process.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method to facilitate high availability in secure network transport comprising:
sending initial uplink traffic from a network node to a first security gateway via a first IPsec tunnel;
monitoring the first IPsec tunnel between the network node and the first security gateway;
monitoring an alternate IPsec tunnel between the network node and a second security gateway;
detecting a failure of the first IPsec tunnel;
performing, in response to detecting the failure, a route update;
routing subsequent uplink traffic to the second security gateway via the alternate IPsec tunnel;
detecting a reestablished IPsec tunnel between the first security gateway and the network node;
performing, in response to detecting the reestablished IPsec tunnel, a route update;
sending additional uplink traffic to the first security gateway via the reestablished IPsec tunnel.

2. The method as recited in claim 1, wherein detecting the failure of the first IPsec tunnel comprises:
detecting the failure by dead peer detection (DPD).

3. The method as recited in claim 1, wherein detecting a reestablished IPsec tunnel between the first security gateway and the network node comprises:
detecting the reestablished IPsec tunnel by dead peer detection (DPD).

4. The method as recited in claim 1, wherein performing, in response to detecting the failure, a route update comprises
updating a routing table to contain a static route to the second security gateway.

5. The method as recited in claim 4, wherein performing, in response to detecting the reestablished IPsec tunnel, a route update comprises
updating the routing table to replace the static route to the second security gateway with a static route to the first security gateway.

6. A method to facilitate high availability in secure network transport comprising:
sending initial downlink traffic from a first security gateway to a network node via a first IPsec tunnel;
detecting a failure of the first IPsec tunnel;
performing, in response to detecting the failure, a route update;
routing subsequent downlink traffic for the network node to a second security gateway;
detecting a reestablished IPsec tunnel between the first security gateway and the network node;
performing, in response to detecting the reestablished IPsec tunnel, a route update;
sending additional downlink traffic to the network node via the reestablished IPsec tunnel.

7. The method as recited in claim 6, wherein detecting the failure of the first IPsec tunnel comprises:
detecting the failure by dead peer detection (DPD).

8. The method as recited in claim 6, wherein routing subsequent downlink traffic for the network node to a second security gateway comprises:
routing the subsequent downlink traffic to the second security gateway to be routed to the network node via an alternate IPsec tunnel.

9. The method as recited in claim 6, further comprising:
attempting to reestablish an IPsec tunnel between the first security gateway and the network node, subsequent to detecting the failure.

10. The method as recited in claim 6, further comprising:
restarting, by the first security gateway and subsequent to detecting the failure, Internet Key Exchange (IKE) with the network node.

11. A network node comprising:
a network interface adapted to send and receive messaging using at least one communication protocol;
a processing unit, communicatively coupled to the network interface,
adapted to send, via the network interface, initial uplink traffic to a first security gateway via a first IPsec tunnel,
adapted to monitor an alternate IPsec tunnel between the network node and a second security gateway,
adapted to detect a failure of the first IPsec tunnel,
adapted to perform, in response to detecting the failure, a route update,
adapted to route subsequent uplink traffic to the second security gateway via the alternate IPsec tunnel,
adapted to detect a reestablished IPsec tunnel between the first security gateway and the network node,
adapted to perform, in response to detecting the reestablished IPsec tunnel, a route update, and
adapted to send, via the network interface, additional uplink traffic to the first security gateway via the reestablished IPsec tunnel.

12. A security gateway comprising:
a network interface adapted to send and receive messaging using at least one communication protocol;
a processing unit, communicatively coupled to the network interface,
adapted to send, via the network interface, initial downlink traffic to a network node via a first IPsec tunnel,
adapted to detect a failure of the first IPsec tunnel,
adapted to perform, in response to detecting the failure, a route update,
adapted to route subsequent downlink traffic for the network node to a second security gateway,
adapted to detect a reestablished IPsec tunnel between the security gateway and the network node,
adapted to perform, in response to detecting the reestablished IPsec tunnel, a route update, and
adapted to send, via the network interface, additional downlink traffic to the network node via the reestablished IPsec tunnel.
